(19) United States
(12) Patent Application Publication
(10) Pub. No.: US 2010/0032076 A1
(43) Pub. Date: Feb. 11, 2010

(54) Roofing Tape with Tabs

(75) Inventors: Tore Turney, West Palm Beach, FL (US); Paul B. Specht, Wilmette, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: TabSeal LLC, Jupiter, FL (US)

(21) Appl. No.: 12/187,980

(22) Filed: Aug. 7, 2008

(51) Int. Cl. B32B 37/12; B32B 3/10

(52) U.S. Cl. 156/71; 428/195.1; 156/66; 156/552; 156/302; 156/574

(57) ABSTRACT

The roofing tape may include a substrate and tabs. The tabs may be attached to the substrate with adhesive. The roofing tape may be made as a seam tape or as a field tape. The seam tape may be used at the seams of the roofing material and the adhesive adheres to the roofing material. The seam tape creates a seal between the edges of adjacent rows of roofing paper in order to prevent water and/or wind from entering the seam. The tape facilitates the proper spacing of the tabs because the tabs are pre-applied to the tape. The tabs can be quickly applied by unrolling the tape. An applicator device may be used for applying the tape to the roofing material. An assembly device for applying the tabs to the substrate may be used. An assembly and applicator device may be used which assembles the tabs to the substrate and then applies the assembled tape to the roofing material.

### BACKGROUND

The roofing material on a building may include an underlayment and an upper layer. The underlayment may be roofing paper. The upper layer may be a material, such as, asphalt shingles, wood shingles, clay tiles, metal sheets, slate, cement, modified bitumen or other material. During windy conditions, such as, strong winds, a hurricane, or tornado, the upper layer may be subject to damage. In some locations, the building code requires the underlayment to be secured with nails and metal tabs. The building code may specify the spacing of the tabs at the seams of the underlayment and in the field of the underlayment between the seams. However, the placement and fastening of the tabs may be labor intensive.

### BRIEF SUMMARY

The roofing tape may include a substrate and tabs. The tabs may be attached to the substrate with adhesive. The roofing tape may be made as a seam tape or as a field tape. The seam tape may be used at the seams of the roofing material and the adhesive adheres to the roofing material. The seam tape creates a seal between the edges of adjacent rows of roofing paper in order to prevent water and/or wind from entering the seam. The seam tape also facilitates the proper spacing of the tabs because the tabs are pre-applied to the tape. Thus, the seam tape assists in compliance with the spacing requirements of the building code. Also, the tabs can be quickly applied to the seam by unrolling the seam tape. This situation avoids the user from applying the tabs individually to their proper location along the seam. Similarly, the field tape facilitates both the application of the tabs and the placement of the tabs in order to comply with the building code. In addition, the tabs on the seam tape and the field tape help to prevent the roofing paper from being blown off of the roof.

An applicator device may be used for applying the tape to the roofing material. The user would position the applicator device over the roofing material and then unroll the tape by pushing the applicator device along the roofing material. An assembly device for applying the tabs to the substrate may be used. The assembly device may include a spindle to dispense a roll of substrate, a feed tube to dispense roofing tabs, and an actuating device disposed below the feed tube to attach the tabs to the substrate. An assembly and applicator device may be used which assembles the tabs to the substrate and then applies the assembled tape to the roofing material.

### BRIEF DESCRIPTION OF THE DRAWINGS

FIG. 1 is a perspective view of the tab and tape roll.

FIG. 2 is a top view of the tab and tape roll.

FIG. 3 is a cross sectional view taken along line 3-3 in FIG. 2.

FIG. 4 is a top view of another embodiment.

FIG. 5 is a top view of another embodiment.

FIG. 6 is a perspective view of another embodiment of the tab and tape roll.

FIG. 7 is another embodiment of the tab and tape roll.

FIG. 8 is a top view of the tape shown in FIG. 7.

FIG. 9 is a perspective view of the tabs and tape applied to the roof.

FIG. 10 is a top view of the tabs and tape applied to the roof as shown in FIG. 9.

FIG. 11 is a cross sectional view taken along line 11-11 in FIG. 10.

FIG. 12 is a cross sectional view taken along line 12-12 in FIG. 10.

FIG. 13 is a perspective view of an applicator device and a roll of the tape with tabs.

FIG. 14 is a perspective view of another embodiment of an applicator device and a roll of the tape with tabs.

FIG. 15A is a perspective view of another embodiment of an applicator device and a roll of the tape with tabs.

FIG. 15B is a perspective view of another embodiment of an applicator device and a roll of the tape with tabs.

FIG. 16 is a perspective view of another embodiment of an applicator device and a roll of the tape with tabs.

FIG. 17 is a perspective view of another embodiment of an applicator device and a roll of the tape with tabs.

FIG. 18 is a rear perspective view of the device shown in FIG. 17.

FIG. 19 is a cross-sectional view taken along line 19-19 in FIG. 18.

FIG. 20 is a cross-sectional view taken along line 20-20 in FIG. 18 showing the cutter engaging the tape.

FIG. 21 is a perspective view of another embodiment of an applicator device.

FIG. 22 is a perspective view of another embodiment of an applicator device.

FIG. 23 is a perspective view of a device for applying the tabs to the substrate.

FIG. 24 is a front view of the device shown in FIG. 23.

FIG. 25 is a partial view of the device show in FIG. 24.

FIG. 26 is a cross-sectional view taken along line 26-26 in FIG. 25 with the first cam under the feed tube.

FIG. 27 is a cross-sectional view taken along line 26-26 in FIG. 25 with the first cam under the feed tube.

FIG. 28 is a cross-sectional view taken along line 28-28 in FIG. 25 with the first cam under the feed tube.

FIG. 29 is a cross-sectional view taken along line 28-28 in FIG. 25 with the first cam under the feed tube.

FIG. 30 is a cross-sectional view taken along line 26-26 in FIG. 25 with the second cam under the feed tube.

FIG. 31 is a cross-sectional view taken along line 26-26 in FIG. 25 with the second cam under the feed tube.

FIG. 32 is a cross-sectional view taken along line 28-28 in FIG. 25 with the second cam under the feed tube.

FIG. 33 is a cross-sectional view taken along line 28-28 in FIG. 25 with the second cam under the feed tube.

FIG. 34 is a rear perspective view of another embodiment of an applicator device.

FIG. 35 is a cross-sectional view of the device shown in FIG. 34.

FIG. 36 is a rear perspective view of another embodiment of an applicator device.

FIG. 37 is a rear perspective view of another embodiment of an applicator device.

FIG. 38 is perspective view of another embodiment of the tab and tape roll

FIG. 39 is a cross-sectional view of the tape in FIG. 38.

FIG. 40 is perspective view of another embodiment of the tab and tape roll.

FIG. 41 is a cross-sectional view of another embodiment of a tape.

FIG. 42 is a top view of another embodiment of a tape.

FIG. 43 is a cross-sectional view of taken along line 43-43 in FIG. 42.

FIG. 44 is a top view of another embodiment of a tape.

FIG. 45 is a top view of the tape in FIG. 38 applied to a seam.

FIG. 46 is a cross-sectional view of taken along line 46-46 in FIG. 45.

FIG. 47 is a top view of another embodiment of a tape.

FIG. 48 is a cross-sectional view of taken along line 48-48 in FIG. 47.

FIG. 49 is a top view of another embodiment of a tape.

### DESCRIPTION

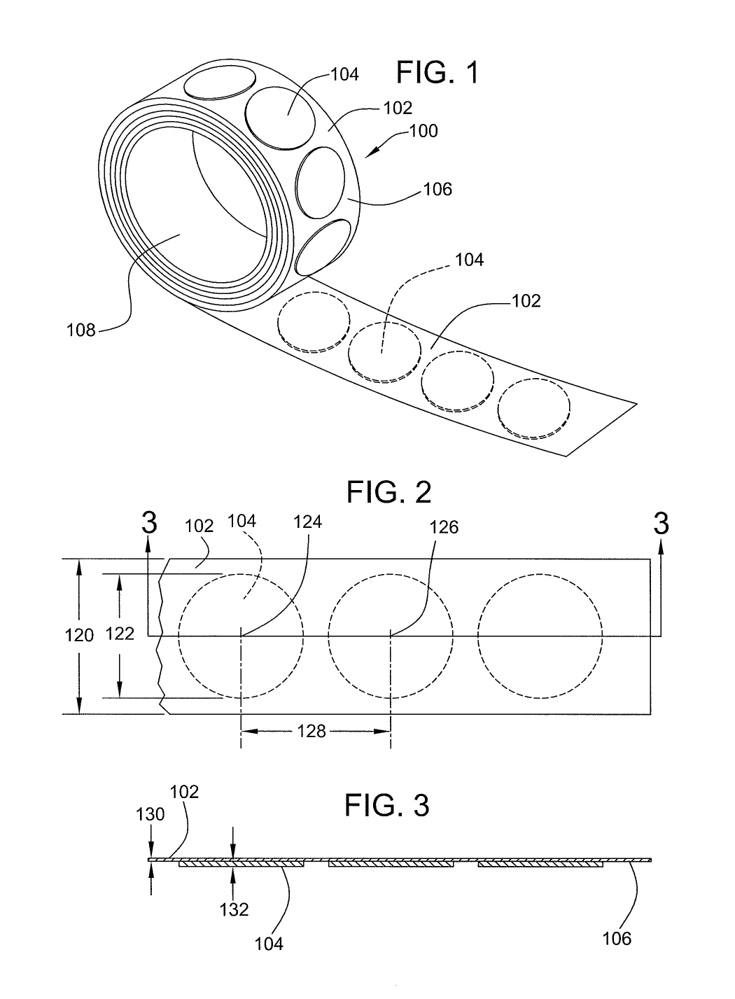

Referring to FIG. 1, the tape 100 may include a substrate 102 and tabs 104. The substrate 102 may be a material, such as, cloth, plastic, rubber, bitumen, or other materials, or combinations thereof. The substrate 102 may include other materials, such as, strings or filaments. The substrate 102 may include an adhesive 106. The tabs 104 may be made of any material, such as, metal or plastic. The metal may be steel, galvanized steel, stainless steel, tin, copper, aluminum, zinc, or other metals or combinations thereof. The tabs may have a coating, such as, Teflon coating, galvanized coating, or other coating. The tabs 104 may have any shape, such as, circular, oval, square, rectangle, hexagon, octagon, other polygons, or other shapes. The tabs may be attached to the substrate with adhesive, sealant, roofing cement, bitumen product, or other technique. If the substrate 102 includes an adhesive, then the tab may be attached to the substrate using the adhesive. The adhesive 106 may be a material, such as, a pressure sensitive adhesive. The tape 100 may be wound upon a core 108. As will be discussed herein, the tape 100 may be used at the seams of the roofing material. In this embodiment, the tape 100 is wound such that the tabs 104 are facing away from the center of the roll and the substrate 102 is positioned between the attached tab and the center of the roll.

Referring to FIG. 2, the substrate 102 may have a width 120. The width 120 may have a first range of about 0.375 inches (0.95 cm) to about 6 inches (15.2 cm), a second range of about 0.5 inches (1.27 cm) to about 4 inches (10.2 cm), and a third range of about 1 inch (2.54 cm) to about 3 inches (7.6 cm). In one embodiment, the width 120 may be about 3 inches (7.6 cm). The tabs 104 may have a width 122. The width 122 may have a first range of about 0.5 inches (1.27 cm) to about 3 inches (7.6 cm), a second range of about 1 inch (2.54 cm) to about 2 inches (5.1 cm), and a third range of about 1.25 inches (3.2 cm) to about 1.675 inches (4.3 cm). In one embodiment, the width 122 may be about 1⅝ inches (4.13 cm). The tabs 104 may have centers 124, 126. The distance 128 from center 124 to center 126 may have a first range of about 0.5 inches (1.27 cm) to about 12 inches (30.5 cm), a second range of about 1 inch (2.54 cm) to about 6 inches (15.2 cm), and a third range of about 1.5 inches (3.8 cm) to about 3 inches (7.6 cm). In one embodiment, the distance 128 is about 2 inches (5.1 cm).

Referring to FIG. 3, the substrate 102 may have a thickness 130. The thickness 130 may have a first range of about 0.005 inches (0.013 cm) to about 0.02 inches (0.05 cm), a second range of about 0.01 inches (0.03 cm) to about 0.018 inches (0.046 cm), and a third range of about 0.011 inches (0.028 cm) to about 0.016 inches (0.041 cm). In one embodiment, the thickness 130 may be about 0.015 inches (0.038 cm). The tab 104 may have a thickness 132. The thickness 132 may have a first range of about 0.008 inches (0.020 cm) to about 0.08 inches (0.20 cm), a second range of about 0.01 inches (0.05 cm) to about 0.018 inches (0.046 cm), and a third range of about 0.012 inches (0.03 cm) to about 0.016 inches (0.041 cm). In one embodiment, the thickness 132 may be about 0.015 inches (0.038 cm).

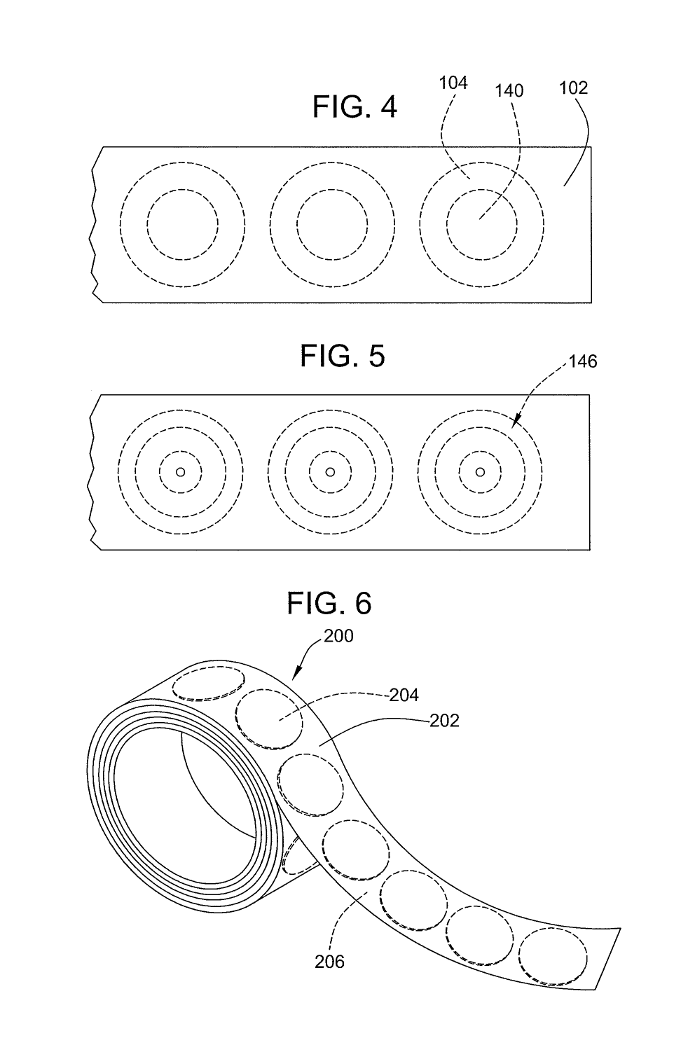

Referring to FIG. 4, another embodiment of the tape with tabs is shown. In this embodiment, a sealant 140 is located between the substrate 102 and the tab 104. The sealant may be silicone, roofing cement, bitumen product, elastomeric compound, or other material or combination thereof. The sealant may help to create a seal around the fastener when a fastener is applied to the tab.

Another embodiment is shown in FIG. 5. In this embodiment, the substrate and/or the tabs include a target 146. In one embodiment the target 146 may be a bulls-eye. In other embodiments, the target 146 may be crosshairs, a dot, or a circle. As will be discussed herein, the target 146 may assist the user in positioning the fastener on the tab.

Referring to FIG. 6, another embodiment of the tape with tabs is shown. In this embodiment, the tape 200 is wound such that the tabs 204 are facing toward the center of the roll and the attached tab 204 is positioned between the substrate 202 and the center of the roll. The substrate 202 may include an adhesive 206.

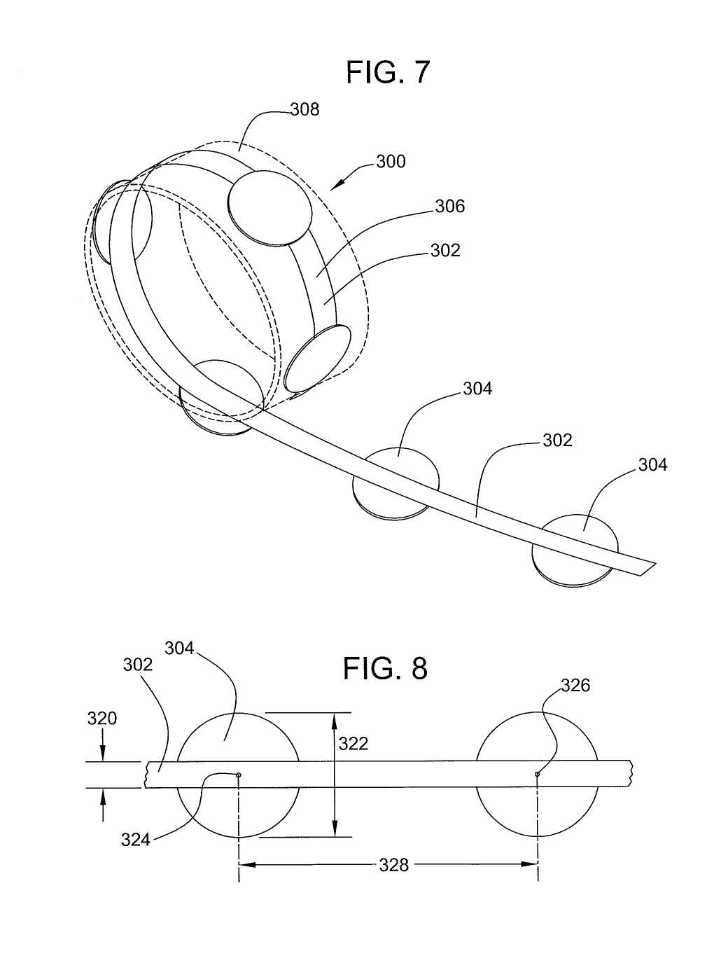

Referring to FIG. 7, another embodiment of the tape with tabs is shown. In this embodiment, the tape 300 may include a substrate 302 and tabs 304. The substrate 302 may include an adhesive 306. The tape 300 may also be wound onto a core 308. As will be discussed herein, the tape 300 may be used in the field of the roofing material.

The substrate 302 may have a width 320. The width 320 may have a first range from about 0.25 inches (0.64 cm) to about 2 inches (5.1 cm), a second range from about 0.25 inches (0.64 cm) to about 1 inch (2.54 cm), and a third range from about 0.375 inches (0.95 cm) to about 0.75 inches (1.91 cm). In one embodiment, the width 320 may be 0.5 inches (1.27 cm). The tab 304 may have a width 322. The width 322 may have a first range from about 0.5 inches (1.27 cm) to about 3 inches (7.6 cm), a second range from about 1 inch (2.54 cm) to about 2 inches (5.1 cm), and a third range from about 1.25 inches (3.2 cm) to about 1.675 inches (4.3 cm). In one embodiment, the width 322 may be 1⅝ inches (4.13 cm). The tabs 304 may have a center 324 and a center 326. The distance 328 from center 324 to center 326 may have a first range from about 1 inch (2.54 cm) to about 12 inches (30.5 cm), a second range from about 2 inches (5.1 cm) to about 8 inches (20.3 cm), and a third range from about 3 inches (7.6 cm) to about 6 inches (15.2 cm). In one embodiment, the distance 328 may be 4 inches (10.2 cm). The thickness of the substrate 302 and the tab 304 may be similar to the embodiment shown in FIG. 3.

The seam tape 100 and field tape 300 may be sold to the user as a roll with the tabs attached to the substrate. In addition, the user may create the seam tape 100 and field tape 300 by purchasing the substrate and the tabs, and using a device to apply the tabs to the substrate as will be described herein.

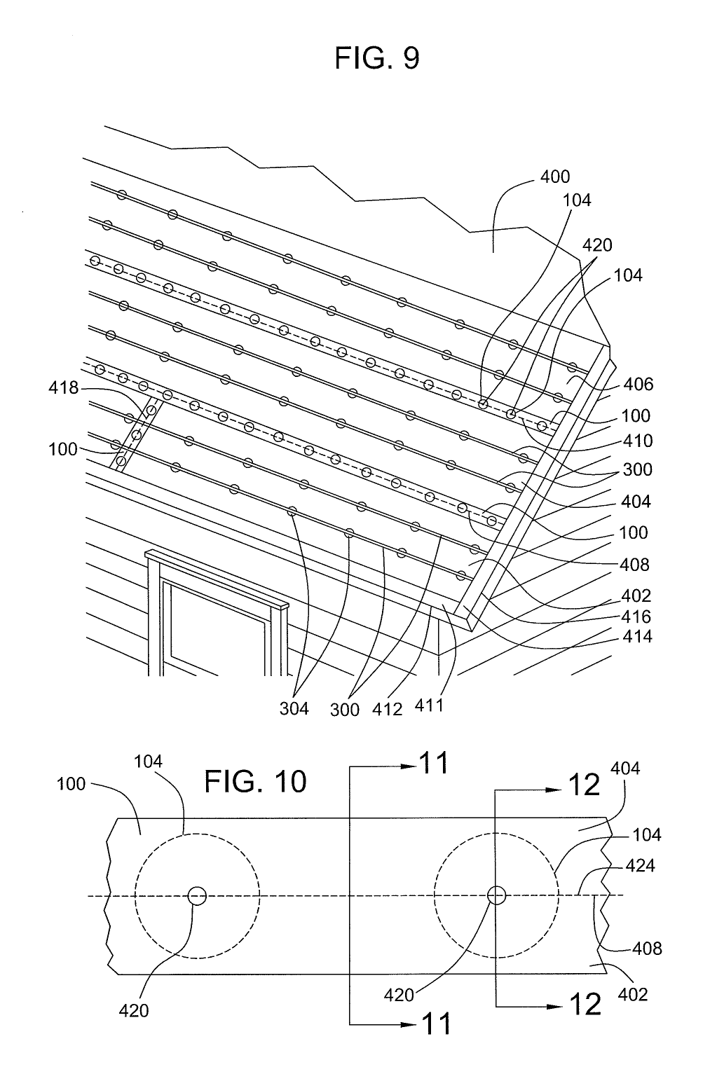

Referring to FIG. 9 illustrates a roof of a building which includes the tape applied to an underlayment, such as, roofing paper. The roof 400 may include several rows of roofing paper 402, 404, 406. The roofing paper would be applied in the following fashion. The first row of roofing paper 402 would be applied to the roof. Then the second row of roofing paper 404 would be applied to the roof and may slightly overlap the roofing paper 402 to create a seam 408. Similarly, roofing paper 406 would be applied to the roof and may slightly overlap roofing paper 404 to create a seam 410. The seam tape 100 can be applied over seam 408 and seam 410. In addition, a drip edge 411, such as, metal flashing, may be applied at the beginning edge 412 of the first row of roofing paper 402. Also, a drip edge or flashing 414 may be applied to the gable edge 416. A ridge vent may be applied to the peak of the roof. Also, the tape 100 could be applied at seams 418 in an existing row of roofing paper 402 when one roll of paper ends and a new roll of paper begins. In addition, the seal tape 300 may be applied to the roofing paper at locations between the seam tape 100. The seam tape 100 and the seal tape 300 are attached to the roof by applying fasteners 420 to the tabs. If the seam tape 100 and the seal tape 300 include an adhesive, then the tapes will adhere to the roofing paper while the user applies a fastener to the tabs.

FIG. 10 shows a top view of the seam tape 100 applied to seam 408. As discussed above, the row of roofing paper 404 may overlap the row of roofing paper 402. Thus, the first row of roofing paper 402 is overlapped by the bottom edge 424 of the second row of roofing paper 404. The edge 424 becomes the seam 408 between roofing paper 402 and roofing paper 404. The tape 100 is positioned so that the tape 100 covers the seam 408.

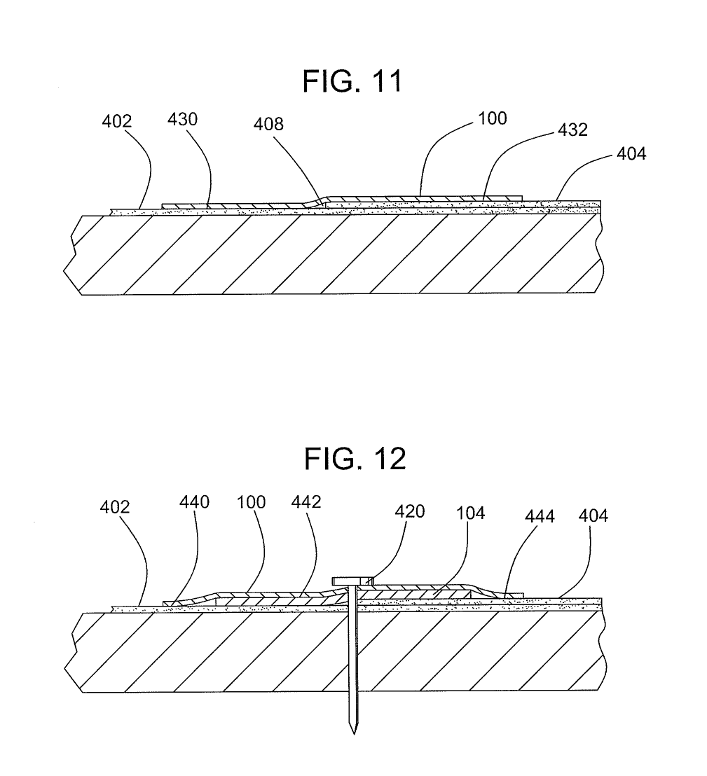

FIG. 11 shows a cross-sectional view through the seam tape 100 at line 11-11 in FIG. 10. The cross-section view is taken through the tape 100 at a location between the tabs 104. Due to the adhesive on the tape 100, the tape attaches to the roofing paper 402 at location 430 and at location 432, on roofing paper 404 in order to create a seal at seam 408.

FIG. 12 shows a cross-sectional view through the seam tape 100 at line 12-12 in FIG. 10. The cross-sectional view is taken through the tab 104 and the fastener 420. Due to the adhesive on the tape 100, the tape adheres to the roofing paper 402 at location 440, to the tab 104 at location 442 and to the roofing paper 404 at location 444. Thus, the tape 100 creates a seal at the seam 408.

The tabs 104 on the tapes 100, 300 help to prevent the roofing paper from being blown off of the roof. The seam tape 100 also creates a seal between the edges of adjacent rows of roofing paper in order to prevent water and/or wind from entering the seam. Thus, if the upper material, such as the asphalt shingles, were blown off the roof in windy conditions, the seam tape 100 would reduce the possibility that water would enter through the seam 408. The seam tape 100 may also be beneficial when the roofing paper is applied to the roof. For example, if the roofer applied the roofing paper and the seam tape 100 to the seams, but was unable to apply the upper material, such as the shingles prior to a rain storm, the seam tape 100 would reduce the possibility of water entering the seam 408.

The seam tape 100 also facilitates the proper spacing of the tabs 104 because the tabs are preapplied to the tape 100. Thus, the seam tape 100 assists in compliance with the spacing requirements of the building code. Also, the tabs 104 can be quickly applied to the seam by unrolling the seam tape 100. This situation avoids the user from applying the tabs individually to their proper location along the seam. Similarly, the field tape 300 facilitates both the application of the tabs 304 and the placement of the tabs 304 in order to comply with the building code. In addition, the tape helps the tabs to remain in place so that the wind does not move the tabs prior to nailing. The seam tape 100 and/or the field tape may be color-coded. The substrate and/or the tabs may include the color-coding. The color-coding of the seam tape 100 and/or field tape 300 may also facilitate the inspection process, as it gives the inspector the ability to immediately know whether the code has been followed by the color of the tape on the roof. For example, the following color combinations may be used: The seam tape may be orange and the field tape may be yellow; the seam tape may be red and the field tape may be green; the seam tape may be white and the field tape may be blue; or the seam tape may be grey and the field tape may be black. Other color combinations may be used as appropriate.

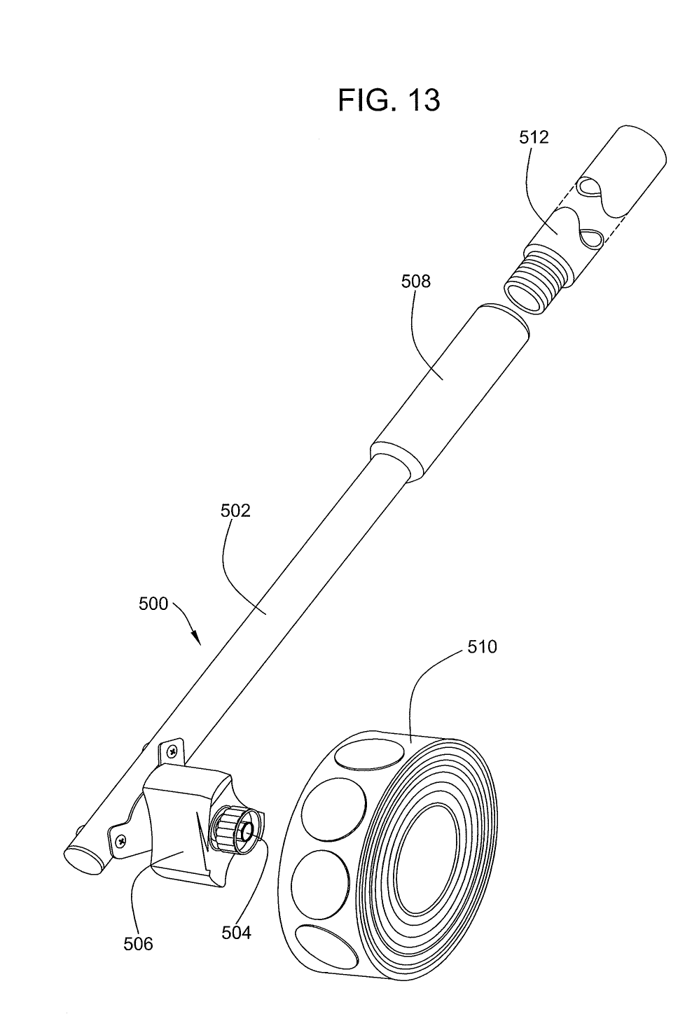

FIG. 13 shows an embodiment of an applicator device for applying a tape to the roofing material. The device 500 may include a shaft 502, a spindle 504, a hub 506, and a handle 508. The user would position the tape 510 over the hub 506. Then the user would position the tape 510 over the roofing material and then unroll the tape 510 by pushing the device 500 along the roofing material. The user may begin the process by unrolling an end portion of the tape 510 and applying the end portion to the roofing material. Then the user unrolls the tape 510 by using the device 500. When the user wishes to stop applying the tape 510, then the user can use a knife to cut the tape 510 and then position the device 500 to a new location. The user may grasp the device 500 on the handle 508 and on the shaft 502 and may apply downward pressure on the device 500 (and thus the tape 510) in order to have the tape 510 adhere to the roofing material. If proper adhesion is not achieved between the tape 510 and the roofing material, then the user can utilize their hands, feet or a roller to apply additional pressure to the tape 510 once it has been applied to the roofing material. The applicator 500 may include an extension handle 512. The extension handle may be attached with screw threads, spring ball and detent or hole, twist lock, pin and hole, or other attachment mechanism.

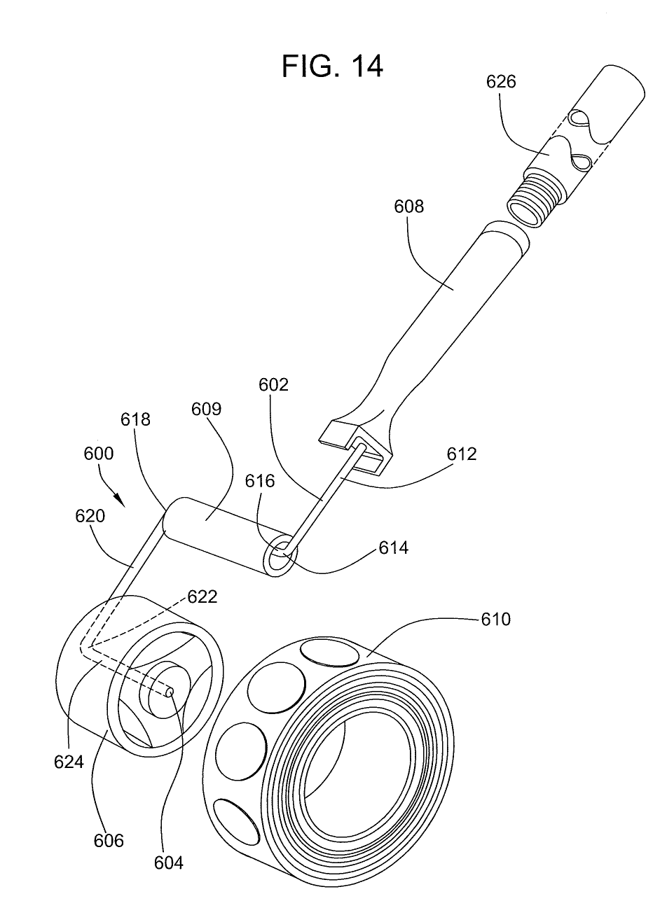

FIG. 14 shows another embodiment of a device for applying a tape to a roofing material. The device 600 may include a shaft 602, a spindle 604, a hub 606, a handle 608 and a handle 609. The shaft 602 may include a first portion 612, a bend 614, a second portion 616, a bend 618, a third portion 620, a bend 622, and a fourth portion 624. The fourth portion may include the spindle 604. The second portion 616 may include the handle 609. The device 600 could be used in a manner similar to device 500, except that the user could hold handle 608 and handle 609 when applying the tape 610. The bends 614, 618, and 622 may be at approximately 90 degrees. The device 600 may include an extension handle 626. The extension handle may be attached with screw threads, spring ball and detent or hole, twist lock, pin and hole, or other attachment mechanism.

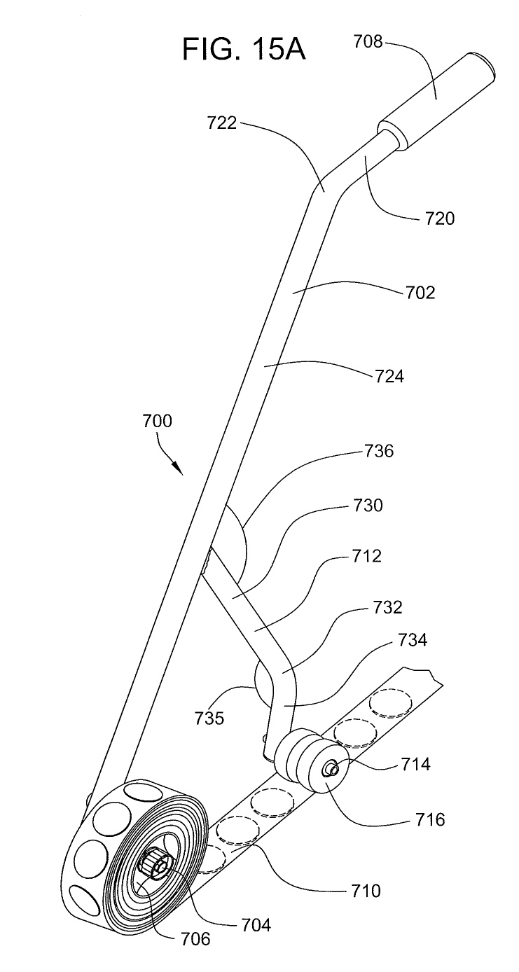

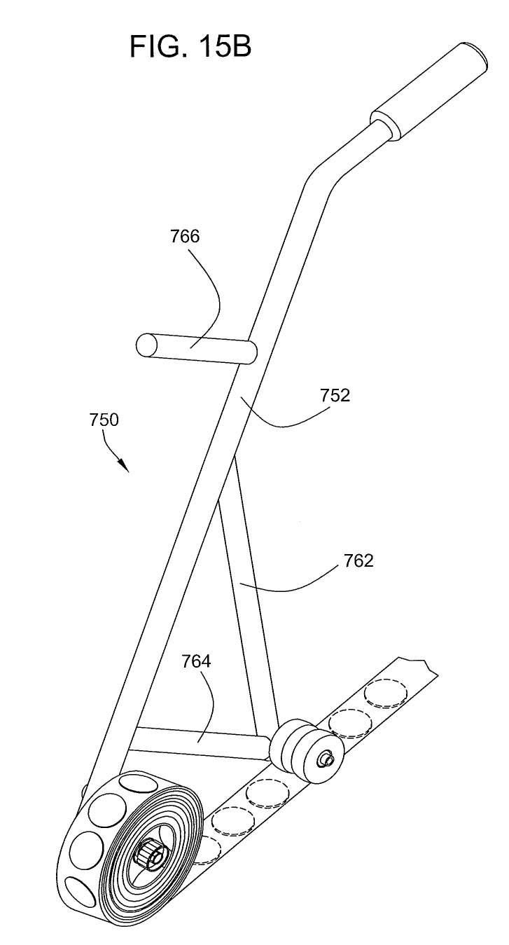

FIG. 15A shows another embodiment of a device for applying a tape to a roofing material. The device 700 may include a shaft 702, a spindle 704, a hub 706, a handle 708, a second shaft 712, a second spindle 714, and a roller 716. The shaft 702 may include a first portion 720, a bend 722, and a second portion 724. The shaft 712 may include a first portion 730, a bend 732, and a second portion 734. The bend 722 may have an angle of approximately 150 degrees. The bend 732 may have an angle 735 of approximately 140 degrees. The shaft 712 may be at an angle 736 with respect to the shaft 702. The angle 736 may be approximately 55 degrees. The device 700 operates in a manner similar to the device 500 except that the roller 716 may be used to apply pressure to the tape 710 after it has been applied to the roofing material.

FIG. 15B shows another embodiment of a device for applying tape to a roofing material. The device 750 is similar to device 700 except as noted below. The second shaft 762 may be straight and the device 750 may include a third shaft 764. The device 750 may include a second handle 766. The third shaft 764 may provide additional support for the second shaft 762. The second handle 766 may provide the user with a better grasp of the device 750 versus grasping the shaft 752.

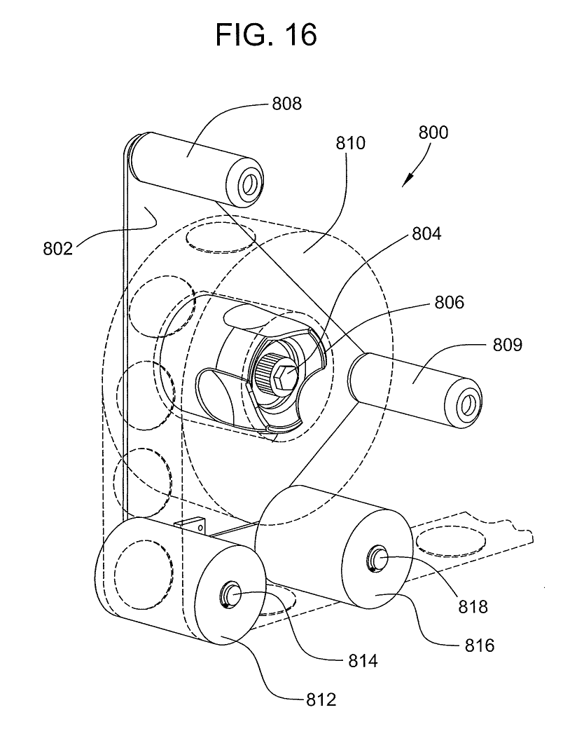

FIG. 16 shows another embodiment of a device for applying a tape to a roofing material. The device 800 may include a support plate 802, a spindle 804, a hub 806, a handle 808, a handle 809, a roller 812, a spindle 814, a roller 816, and a spindle 818. The user would operate the device 800 in the following manner. The user would position the tape 810 over the hub 806. Then the user would begin the process of unrolling an end portion of the tape 810 and applying the end portion to the roofing material. Then the user unrolls the tape 810 by using the device 800. The user may move the device 800 by using the handle 808 and the handle 809 and may apply downward pressure on the device 800 in order to have the tape 810 adhere to the roofing material. The roller 812 and roller 816 may assist in applying pressure to the tape 810 to assist in adhering the tape 810 to the roofing material. When the user wishes to stop applying the tape 810, then the user can use a knife to cut the tape 810 and then position the device 800 to a new location.

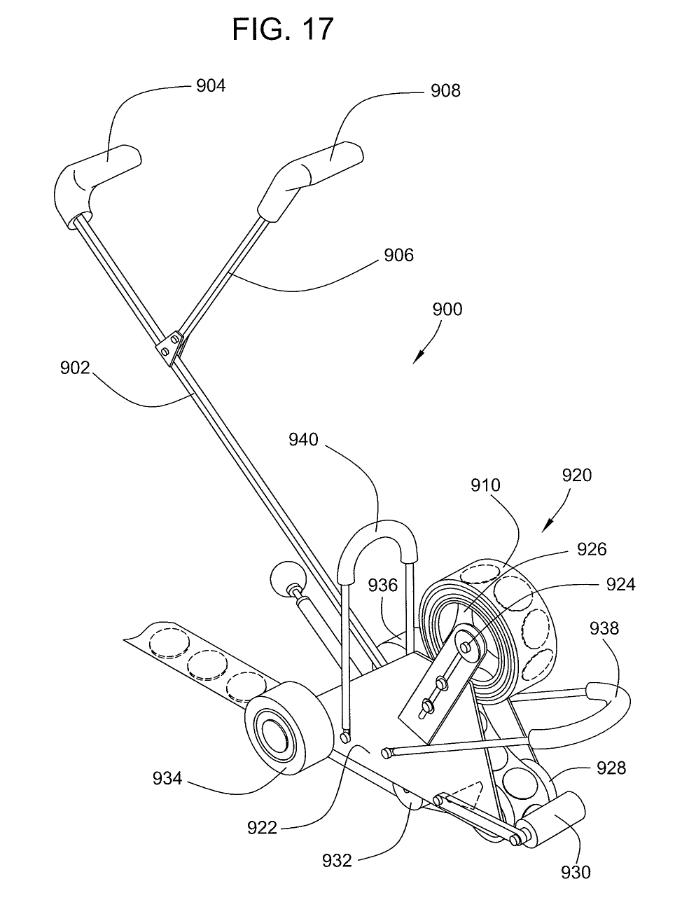

FIG. 17 shows another embodiment of a device for applying a tape to a roofing material. The device 900 may include a shaft 902, a handle 904, a second shaft 906, a second handle 908, and an applicator mechanism 920. The applicator mechanism 920 may include a frame 922, a spindle 924, a hub 926, a roller 928, a guide roller 930, a pressure roller 932, wheels 934, 936, a handle 938, a second handle 940, and a cutter mechanism 942.

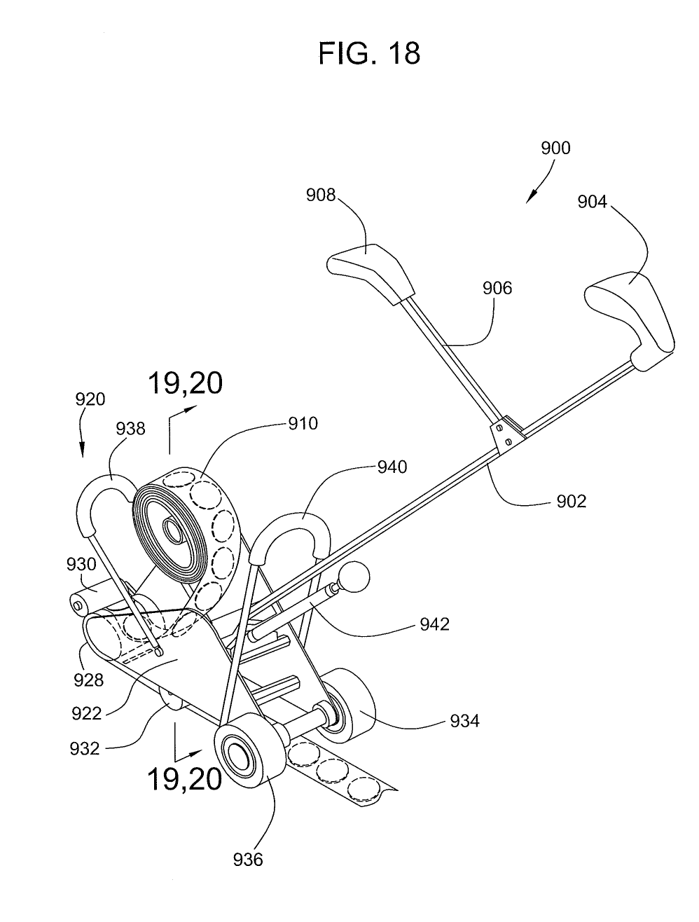

Referring to FIGS. 17 and 18, the user may use the device 900 in a standing or walking position by holding the handles 904, 908 to push the device along the roofing material. In addition, the user may use the device 900 by kneeling or squatting and holding the device 900 by the handles 938, 940. The shaft 902 is removable and the user may remove the shaft 902 when using handles 938, 940.

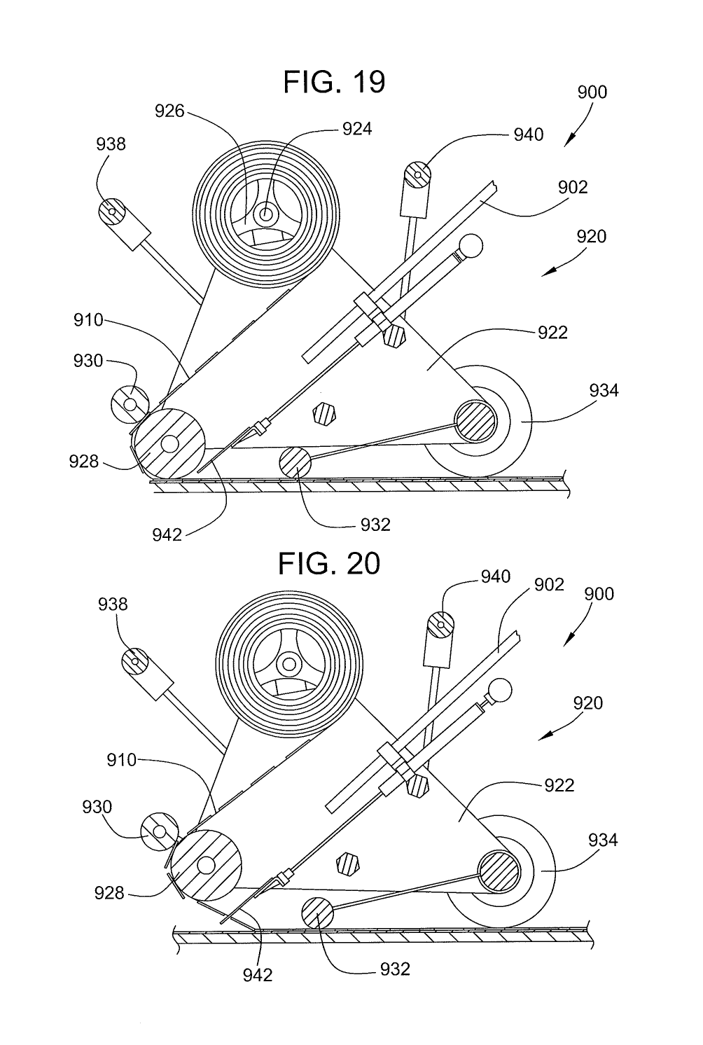

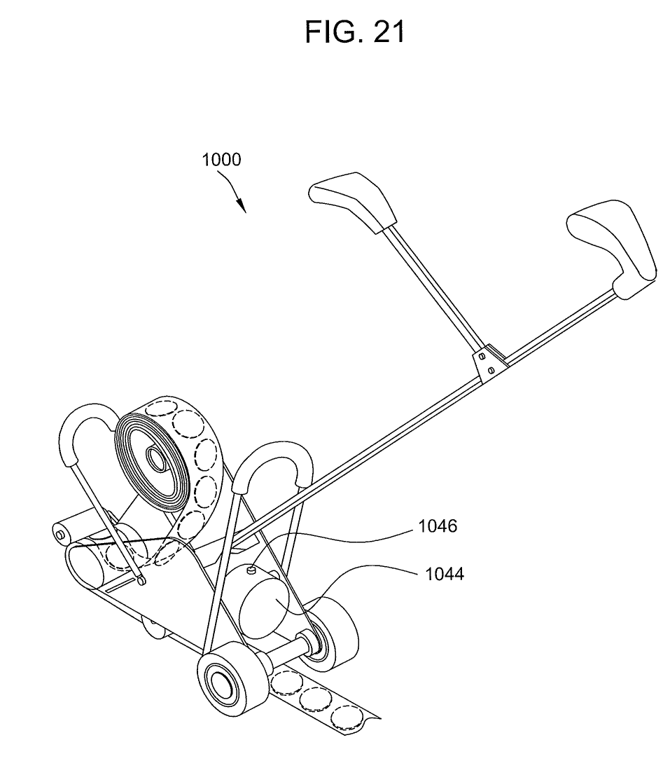

The device 900 operates in the following manner. The user would push the device along the roofing material using the handles 908, 904 or the handles 938, 940. Referring to FIG. 19, the tape 910 would be applied to the roofing material by a roller 928. As the user continues to push the device 900 the pressure roller 923 applies additional pressure to the tape 910 to adhere the tape to the roofing material. In addition, the tape would unroll from the roll of tape 910 which is located on the hub 926 and spindle 924. The tape 910 would advance between the guide roller 930 and the roller 928. When the user wishes to stop applying the tape 910, the user can push the cutting device 942 in order to cut the tape 910 as shown in FIG. 20. After the tape 910 is cut, the cutting device 942 may return by use of a spring or other mechanism. The user can then position the device 900 to a new location.

FIG. 21 shows another embodiment of a device for applying a tape to a roofing material. The device 1000 is similar to the device 900 but may include an actuation device 1044 for the cutter mechanism. The actuation device 1044 may be powered by air, electricity, combustion engine or other energy source. The air may be from a compressor, a storage tank with compressed air, a carbon dioxide cartridge or other air source. The electricity may be from an AC electrical source, a DC electrical source (such as, a battery), or other electrical source. The actuation device 1044 may be actuated by pressing button 1046. The button may be foot or hand operated. In other embodiments, the button may be larger or smaller in size and may be positioned in other locations, such as, the back of the actuation device (facing the user of the device) and/or the handles.

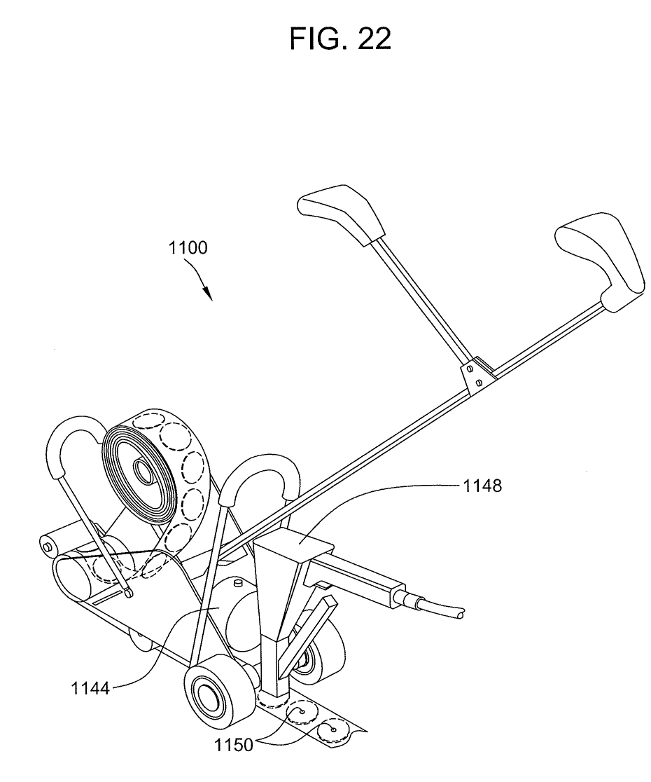

FIG. 22 shows another embodiment of a device for applying a tape to a roofing material. The device 1100 is similar to device 1000 and may include a fastener mechanism 1148 for applying fasteners 1150 to the tabs. The fastener mechanism 1148 may be a nail gun, such as, a pneumatic nail gun, an electric nail gun, a combustion engine nail gun, or other type of nail gun. The device 1100 may include an actuator 1144. In another embodiment, the device 1100 may not include the actuator.

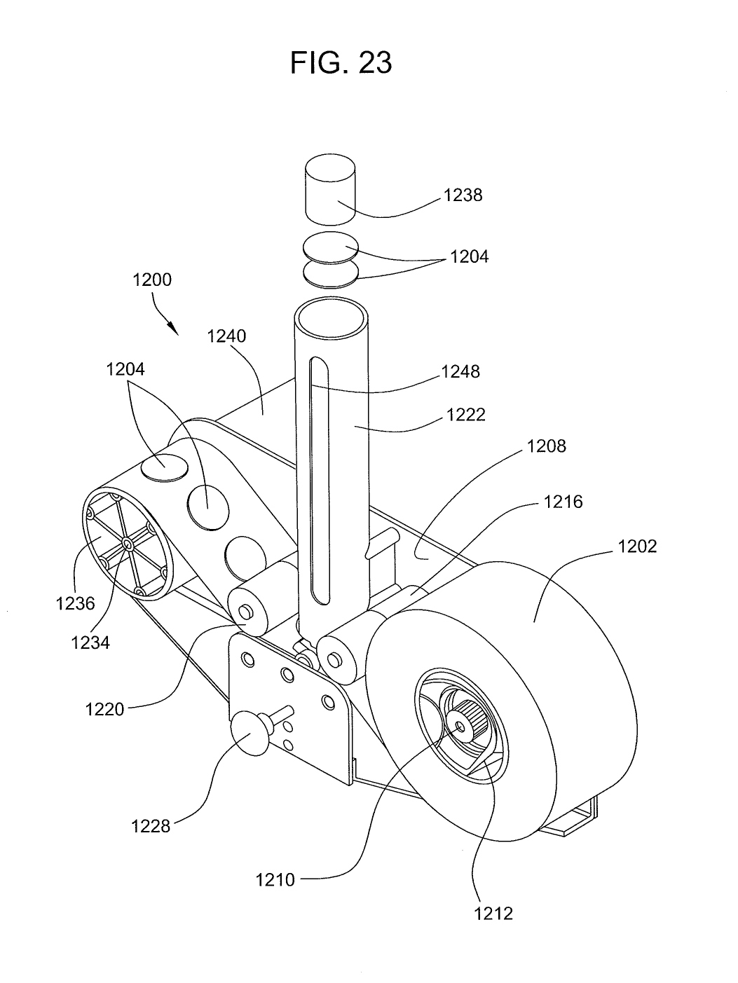

FIG. 23 shows a device for applying the tabs to the substrate. The device 1200 may include a support plate 1208, a spindle 1210, a hub 1212, rollers 1214, 1216, 1218, 1220, a feed tube 1222, cams 1224, 1226, a cam selector 1228, a spindle 1234, a hub 1236, a weight 1238, and a drive mechanism 1240. The device 1200 may operate in the following manner. The user may attach a roll of substrate 1202 to the hub 1212 which is connected to spindle 1210. The user may then position the substrate 1202 through the rollers 1214, 1216, and between the bottom of the feed tube 1222 and the cams 1224, 1226. The user then positions the substrate 1202 through rollers 1218, 1220 and on to hub 1236 which is connected to spindle 1234. The user would then load the tabs 1204 into the feed tube 1222. The device may use a weight 1238 to apply downward pressure on the tabs 1204.

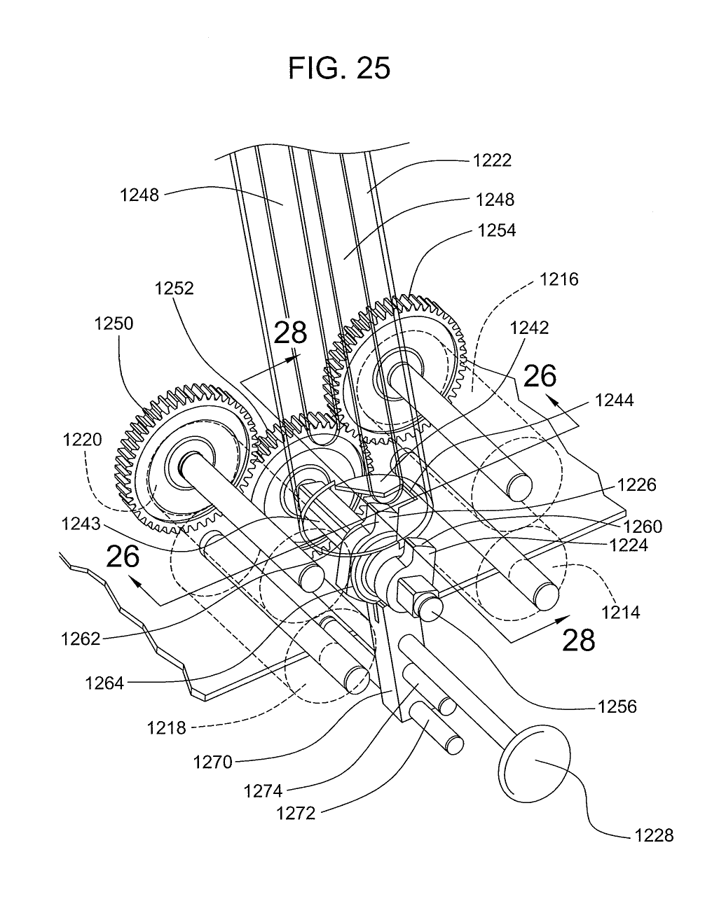

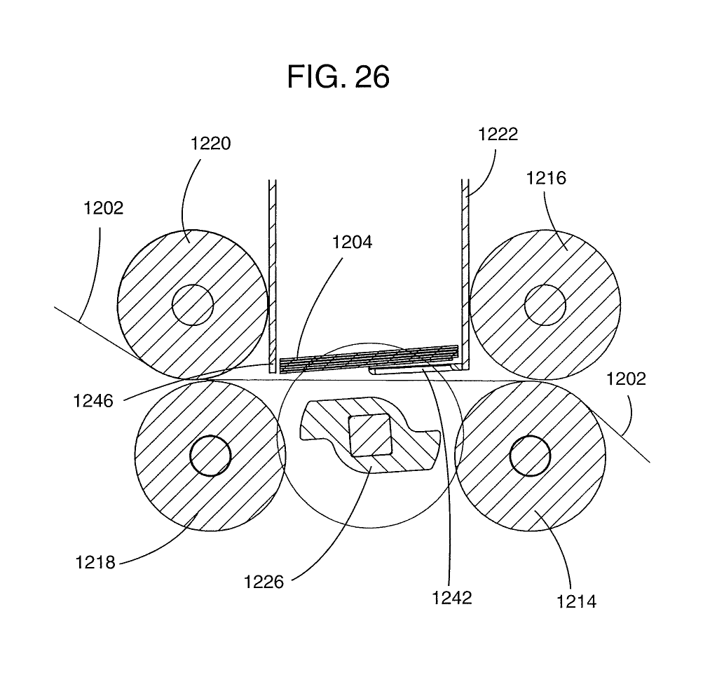

Referring to FIG. 25, the feed tube 1222 may include a bottom shelf 1242 which may hold the stack of tabs 1204 at the bottom of the feed tube 1222. The feed tube 1222 may have an opening 1243 which allows the tabs 1204 to exit the feed tube 1222. The shelf 1242 may have an opening 1244 to accommodate the cam 1224 or the cam 1226. Referring to FIG. 26, the shelf 1242 may be at an angle with respect to the sidewalls of the tube 1222 so that the tabs 1204 can rest at an angle with respect to the sidewalls of the tube 1222. The angle of the shelf 1242 may facilitate the exit of the tabs 1204 from the trailing end 1246 of the tube 1222. Referring to FIG. 25, the tube may include slots 1248 which allow the user to see the amount of tabs in the feed tube 1222. Also, the slots 1248 may allow the user to remove the tabs from the top of the feed tube 1222 by inserting their fingertips in the slots 1248 and removing the tabs 1204 from the top of the feed tube 1222.

Referring to FIG. 23, the device 1200 may include a drive mechanism 1240. The drive mechanism 1240 may be an electric motor, a hand crank, an air motor, a combustion engine, or other energy source. The electricity may be from an AC electrical source, a DC electrical source (such as, a battery), or other electrical source. The air may be from a compressor, a storage tank with compressed air, a carbon dioxide cartridge or other air source. The drive mechanism 1240 may be attached to the spindle 1234 and/or to the gears 1250, 1252, 1254 as shown in FIG. 25. The gear 1250 may be connected to roller 1220 and the gear 1254 may be connected to roller 1216. The gear 1252 may be connected to cam shaft 1256.

Referring to FIG. 25, the cam shaft 1256 may include cam 1224 and cam 1226. The cam 1224 may have a single lobe 1260. The cam 1226 may have a first lobe 1262 and a second lobe 1264. In other embodiments, the cams may have three or more lobes. The cam 1224 may be used to make tapes where the tabs 1204 are spaced a predetermined distance apart on center, such as 4 inches (10.2 cm) on center. The cam 1226 may be used to make tapes where the tabs are spaced a predetermined distance apart on center, such as, 2 inches (5.1 cm) on center. The device 1200 may include a cam selector 1228 which allows the user to position the appropriate cam below the feed tube 1222. For example, the user could pull the cam selector 1228 toward the front of the device 1200 in order to position cam 1226 under the feed tube 1222. If the user wishes to select cam 1224, then the user can push the cam selector 1228 towards the rear of the device 1200 in order to position the cam 1224 under the feed tube 1222. The cam selector 1228 may include a sliding block 1270 and slide rods 1272, 1274 which may assist in the movement of the cam selector 1228 and the cams 1224, 1226.

Referring to FIG. 23, the assembly device 1200 would operate in the following manner. The user would load the machine with the substrate 1202 and the tabs 1204 as noted above. The user would then use the cam selector 1228 to select the appropriate cam for the desired spacing of the tabs 1204 on the substrate 1202. The user would then activate the drive mechanism 1240 to begin the movement of the substrate 1202 through the assembly device 1200.

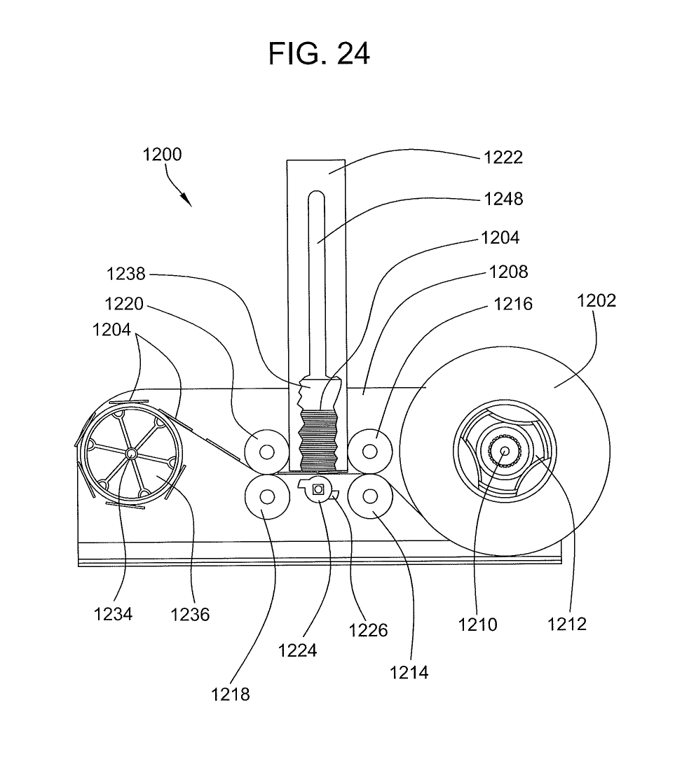

Referring to FIG. 24, the substrate 1202 unwinds from the roll of substrate 1202 and proceeds to rollers 1214, 1216. The substrate 1202 then proceeds between the feed tube 1222 and the cams 1224, 1226. The lobe on the cam will engage the substrate and cause the tab 1204 to be attached to the substrate 1202. The process of attaching the tab to the substrate will be described in more detail below. The substrate 1202 with the tabs 1204 then proceed through the rollers 1218, 1220 and are wound upon the spindle 1234 and the hub 1236. After a sufficient length of substrate 1202 with tabs 1204 is assembled by the assembly device 1200, the user may stop the assembly device 1200 and remove the assembled tape from the assembly device 1200. The user then may use the tape as noted herein by applying it by hand to the roofing material or by using one of the applicator devices described herein.

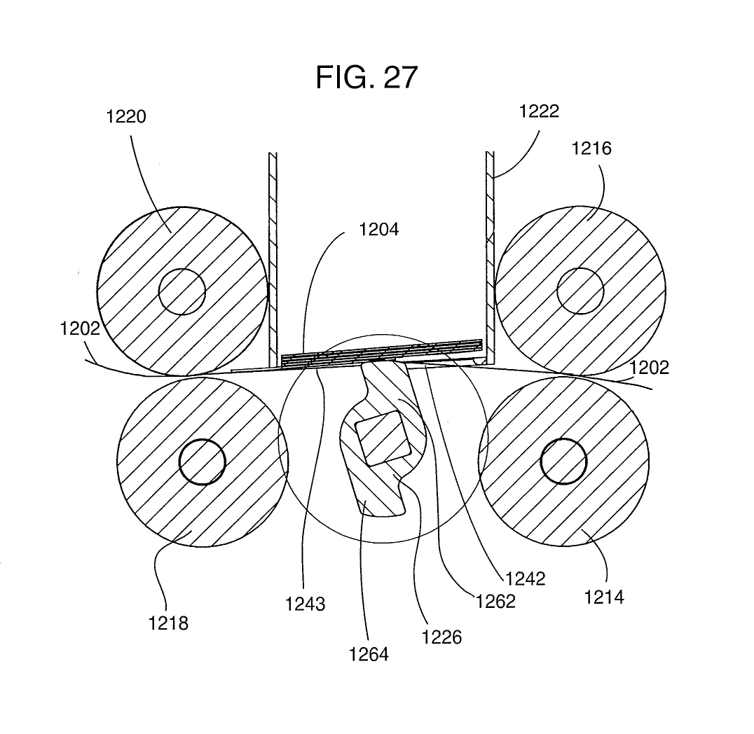

Referring to FIG. 26, the cam 1226 is located below the feed tube 1222. The cam 1226 is shown in a relatively horizontal position. As the substrate 1202 advances between the rollers 1214, 1216 and rollers 1218, 1220, the cam 1226 will rotate in a counterclockwise direction. Referring to FIG. 27, as the cam 1226 rotates, the cam lobe 1262 engages the substrate 1202 and causes the substrate 1202 to move upward. As the substrate 1202 moves upward, the substrate 1202 contacts the tab 1204 which is at the bottom of the feed tube 1222. In this embodiment, the substrate 1202 may include an adhesive on the surface of the substrate which will engage the tab 1204. Thus, due to the adhesive, the tab 1204 would adhere to the substrate 1202. As the substrate 1202 continues to move forward, the tab 1204 will exit the opening 1243 at the bottom of the feed tube. As the bottom tab 1204 exits the feed tube 1222, the next tab 1204 will be positioned at the bottom of the stack of tabs 1204 in the feed tube 1222 and the next tab 1204 will rest upon the shelf 1242. As the cam 1226 continues to rotate in a counterclockwise direction, the cam lobe 1266 will no longer contact the substrate 1202 and the substrate 1202 will return to a position as shown in FIG. 26. As the substrate 1202 and the cam 1226 continue to move, the next cam lobe 1264 will engage the bottom of the substrate 1202 and continue the process. In this embodiment, the cam 1226 will space the tabs 1204 a predetermined distance apart on center, such as, 2 inches (5.1 cm) on center.

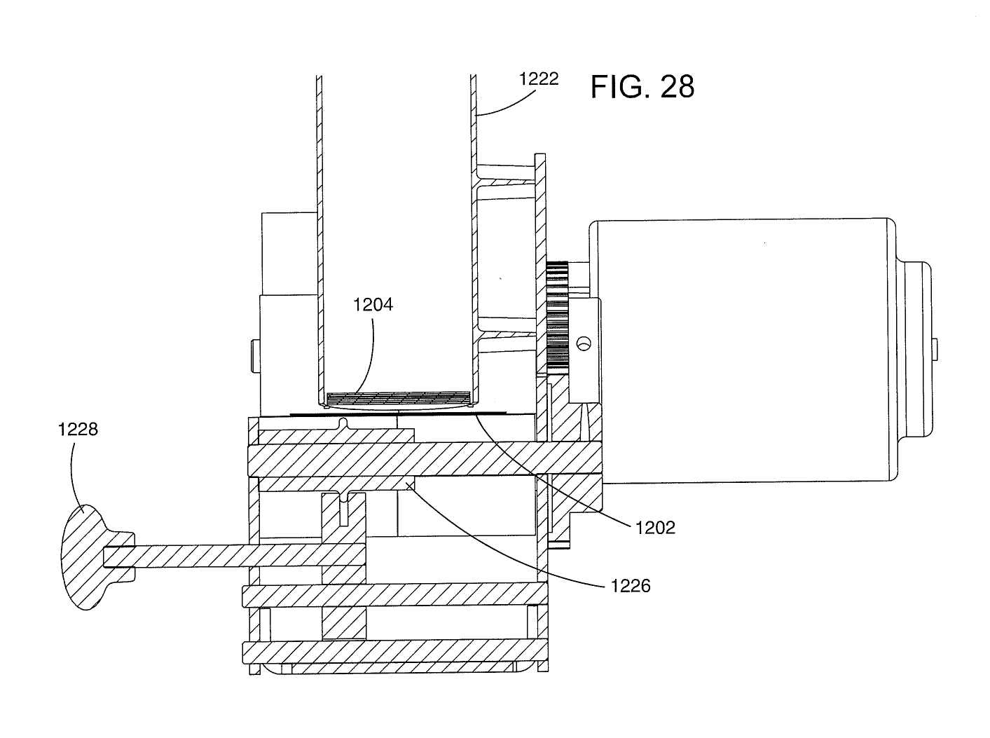

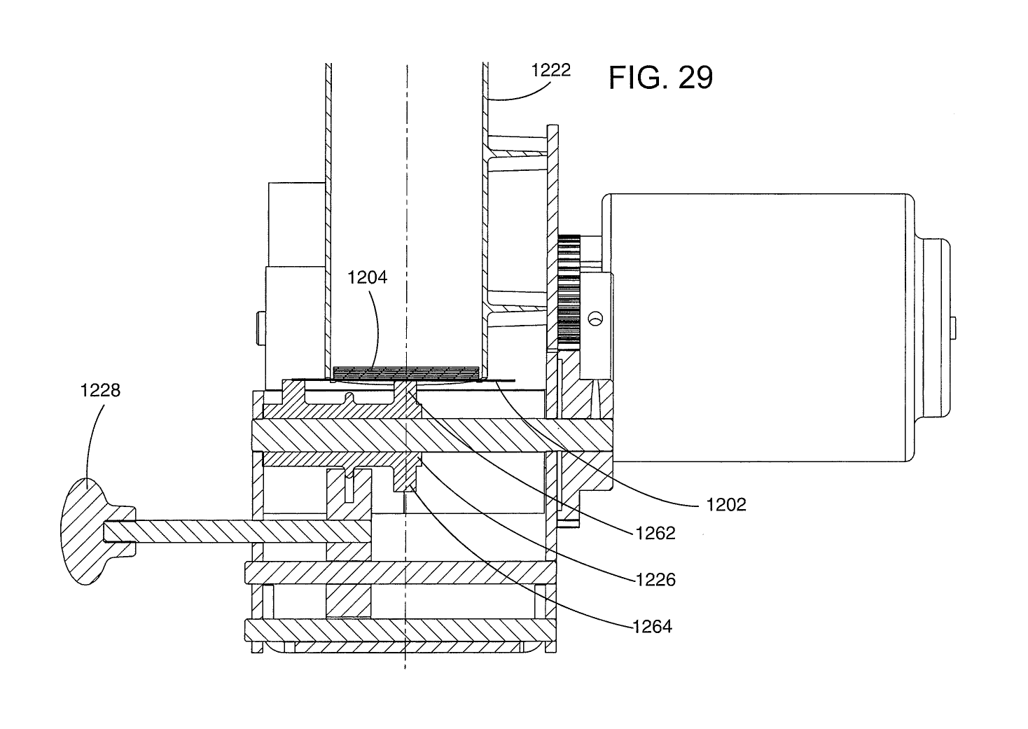

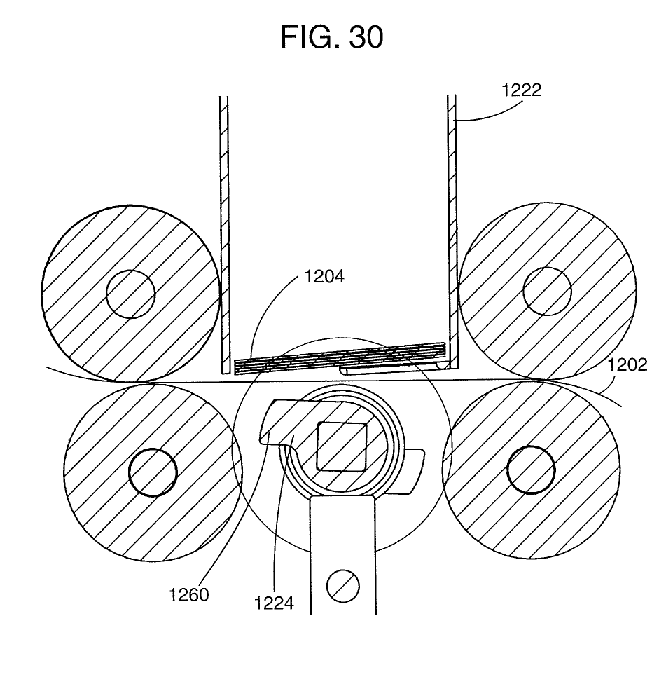

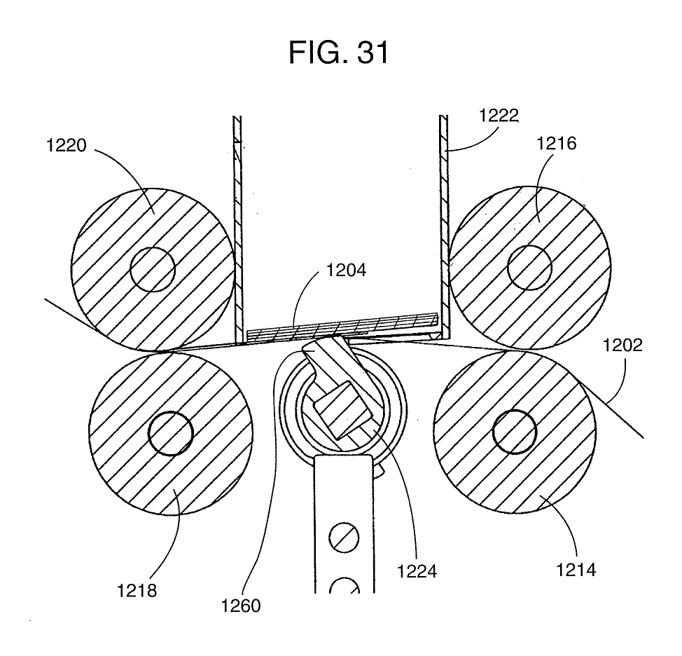

FIG. 28 shows the cam 1226 wherein the cam lobes are in a horizontal position and are not engaging the substrate 1202. FIG. 29 shows the cam 1226 in a vertical position and the cam lobe 1262 is engaging the substrate 1202 and the substrate 1202 is engaging the bottom tab 1204.

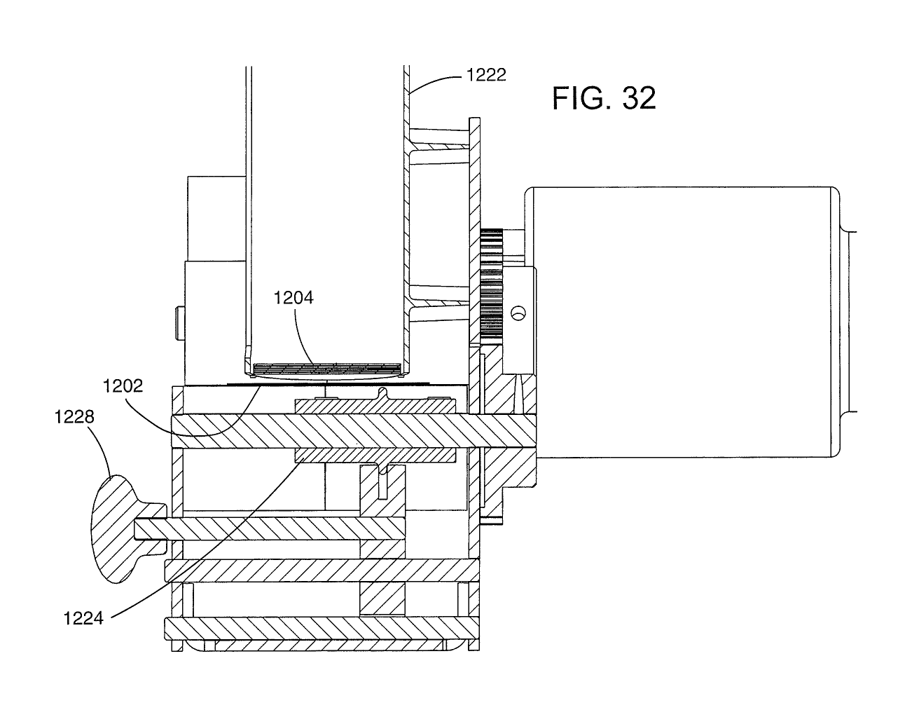

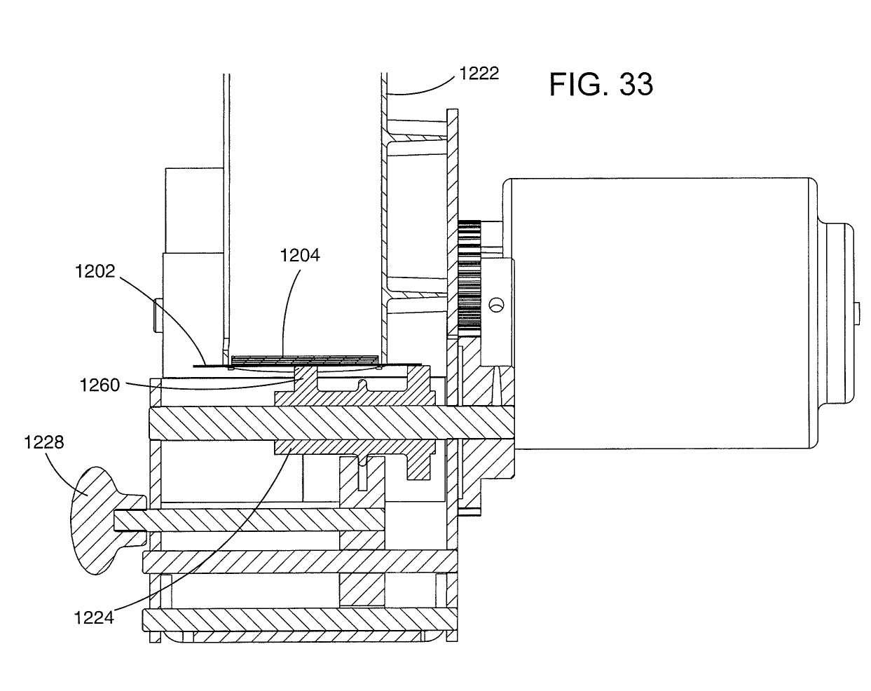

Referring to FIG. 30, the cam 1224 is shown under the feed tube 1222. The cam 1224 is shown with the cam lobe 1260 in a horizontal position. The cam 1224 operates in a manner similar to cam 1226 except that only one tab 1204 is engaged during one revolution of the cam 1224. FIG. 31 shows the cam lobe 1260 engaging the substrate 1202. Referring to FIG. 32, the cam 1224 is located under the feed tube 1222. The location of the cam has been changed by moving cam selector 1228 to the right as can be seen by comparing FIG. 28 with FIG. 32. FIG. 33 shows the cam lobe 1260 engaging the substrate 1202 and the substrate 1202 engaging the bottom tab 1204.

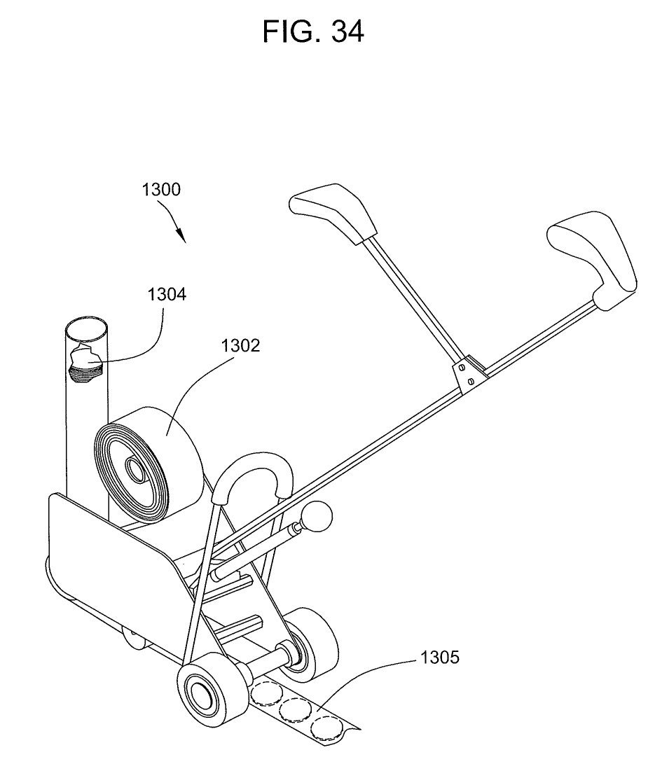

FIG. 34 shows an embodiment of an applicator device 1300 which assembles the tabs 1304 to the substrate 1302 and then applies the assembled tape 1305 to the roofing material. The device 1300 is similar to the device 900 shown in FIGS. 17 and 18, except for the assembly of the tabs 1304 to the substrate 1302.

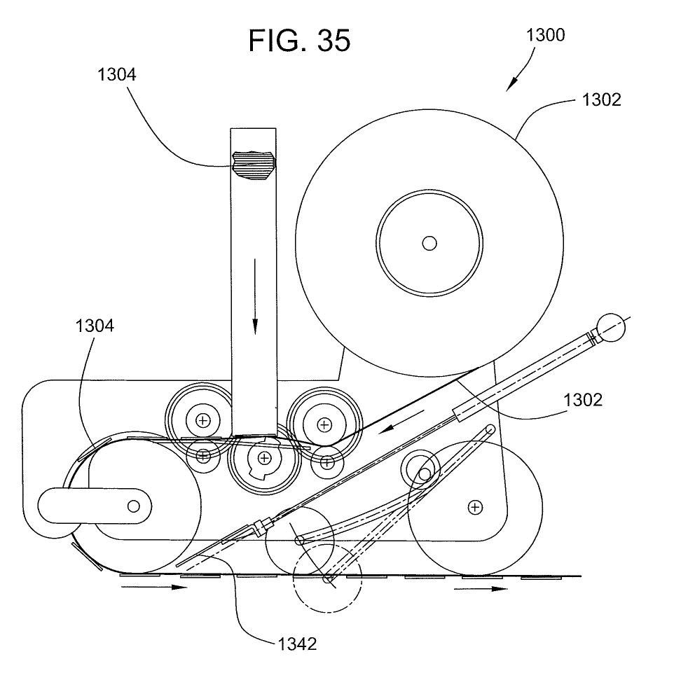

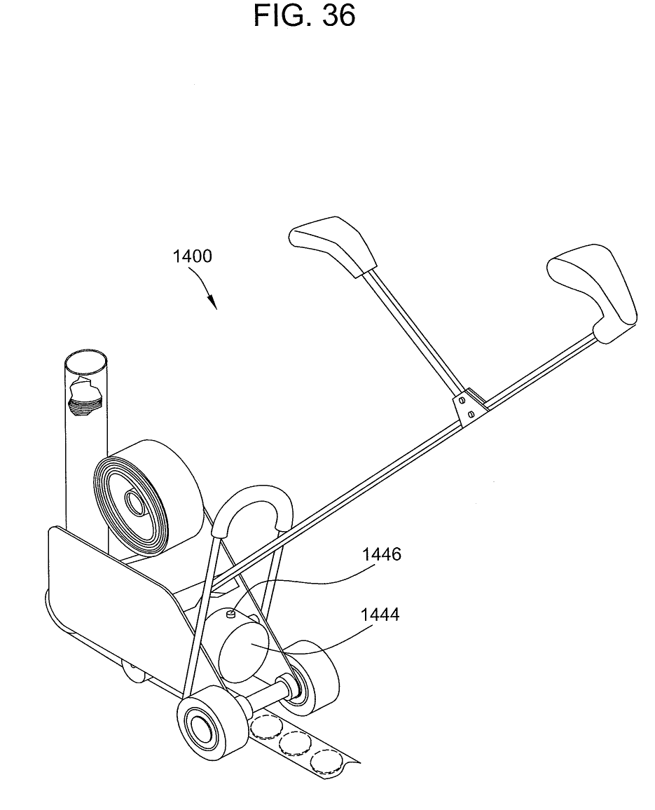

FIG. 35 is a schematic cross-sectional view of the device shown in FIG. 34. The assembly portion of the device 1300 operates in a manner similar to the assembly device 1200 which is shown in FIGS. 23 and 24. After the tabs 1304 have been assembled to the substrate 1302, the assembled tape 1305 is then applied to the roofing material in a fashion similar to the device 900 shown in FIGS. 17 and 18. The device 1300 may include a cutting device 1342 in order to cut the tape 1305.

FIG. 36 shows another embodiment of an assembly and applicator device. The device 1400 is similar to the device 1300 but may include an actuation device 1444 for the cutter mechanism. The actuation device 1444 may be powered in the same manner as the actuation device 1044 as noted herein. The actuation device 1444 may be actuated by pressing button 1446. The button may be foot or hand operated. In other embodiments, the button may be larger or smaller in size and may be positioned in other locations, such as, the back of the actuation device (facing the user of the device) and/or the handles.

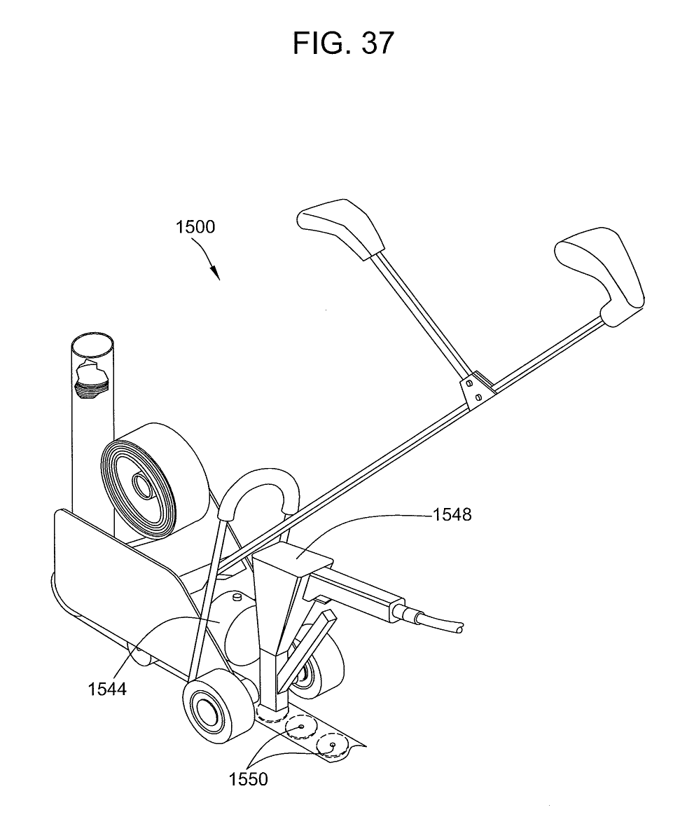

FIG. 37 shows another embodiment of a device for assembling the tape and applying the tape. The device 1500 is similar to device 1400 and may include a fastener mechanism 1548 for applying fasteners 1550 to the tabs. The device 1500 may include an actuator 1544. In another embodiment, the device 1500 may not include the actuator.

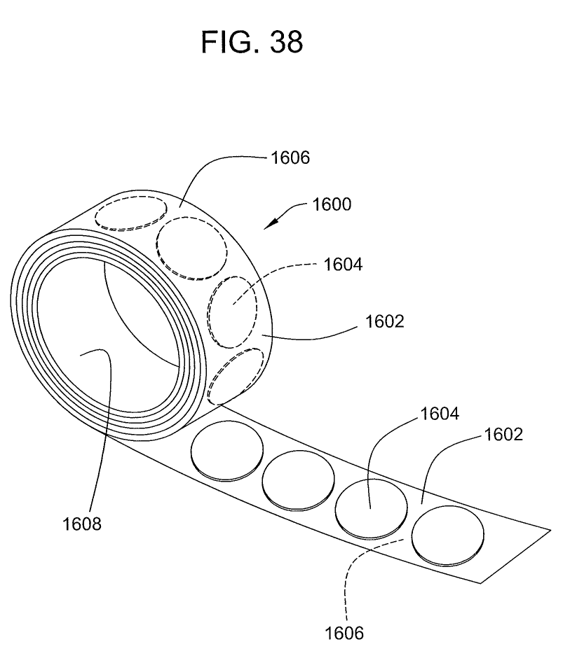

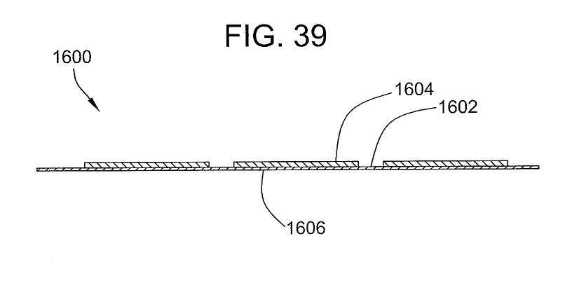

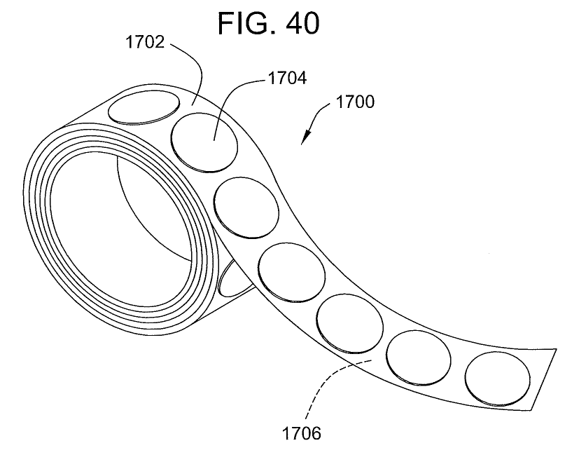

FIGS. 38 and 39 show another embodiment of a tape with tabs. In this embodiment, the tape 1600 may include a substrate 1602 and tabs 1604. The substrate 1602 may include an adhesive 1606 on the side of the substrate which is opposite the side with the tabs 1604. In other embodiments, the substrate may include an adhesive on both sides of the substrate 1602. Referring to FIG. 38, the tape may be wound upon a core 1608. In this embodiment, the tape 1600 is wound such that the tabs 1604 are facing toward the center of the roll and the attached tab is positioned between the substrate and the center of the roll.

Referring to FIG. 40, another embodiment of a tape with tabs is shown. In this embodiment, the tape 1700 is wound such that the tabs 1704 are facing away from the center of the roll and the substrate 1702 is positioned between the attached tab and the center of the roll. The substrate 1702 may include an adhesive 1706 on the side of the substrate which is opposite the side with the tabs 1704. In other embodiments, the substrate may include an adhesive on both sides of the substrate 1702.

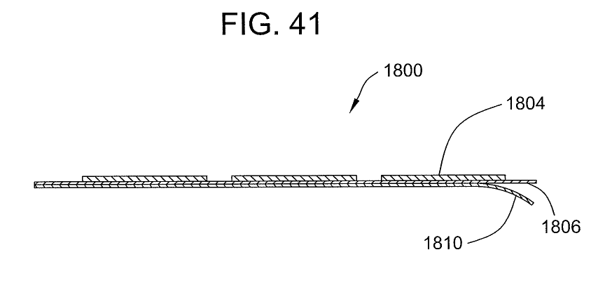

Referring to FIG. 41, another embodiment of a tape with tabs is shown. In this embodiment, the tape 1800 may include a release liner 1810 which may be attached to the adhesive 1806. The release liner 1810 may help to prevent the adhesive 1806 from attaching to the tabs 1804 when the tape 1800 is unrolled from the roll. The release liner 1810 would be removed prior to application to the roofing material.

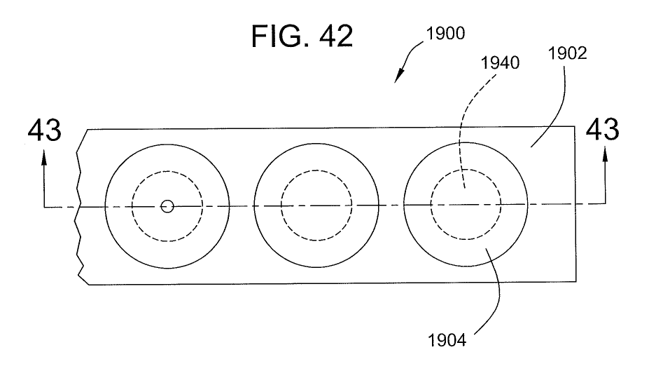

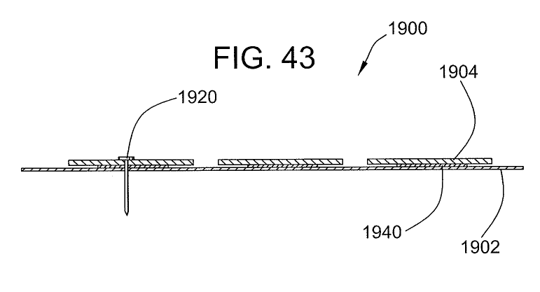

Referring to FIGS. 42 and 43, another embodiment of a tape with tabs is shown. In this embodiment, the tape 1900 may include a sealant 1940 which is located between the substrate 1902 and the tab 1904. The sealant 1940 may be used to attach the tab 1904 to the substrate 1902. The sealant 1940 may help to create a seal around the fastener 1920 when a fastener is applied to the tab 1904.

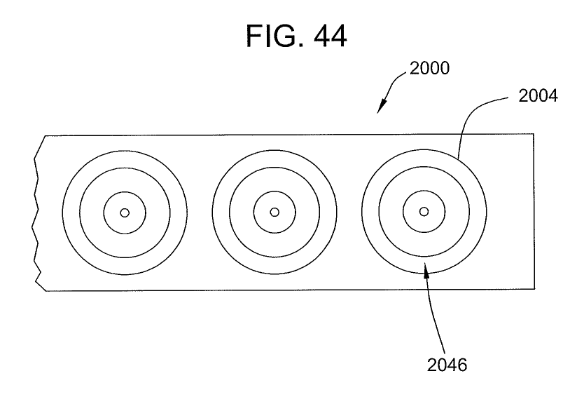

Referring to FIG. 44, another embodiment of a tape with tabs is shown. In this embodiment, the tape 2000 may include tabs 2004 which include a target 2046. The target 2046 may be similar to the embodiments described herein. The target 1046 may assist the user in positioning the fastener on the tab.

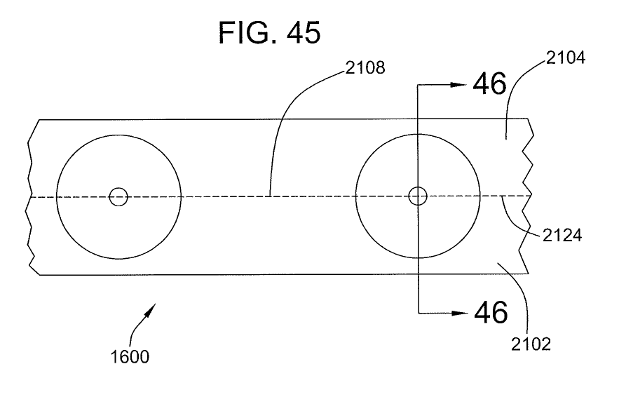

FIG. 45 shows a top view of the seam tape 1600 applied to a seam 2108. As discussed herein, the row of roofing paper 2104 may overlap the roll of roofing paper 2102. Thus, the first row of roofing paper 2102 is overlapped by the bottom edge 2124 of the second row of roofing paper 2104. The edge 2124 becomes the seam 2108 between the roofing paper 2102 and the roofing paper 2104. The tape 1600 is positioned so that the tape 1600 covers the seam 2108.

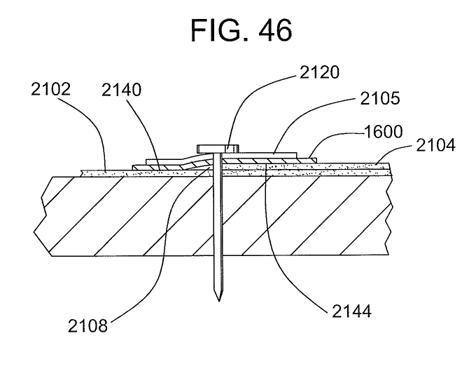

FIG. 46 shows a cross-sectional view through the seam tape 1600 at line 46-46 in FIG. 45. The cross-sectional view is taken through the tab 2105 and the fastener 2120. Due to the adhesive on the tape 1600, the tape adheres to the roofing paper 2102 at location 2140 and to the roofing paper 2104 at location 2144. Thus, the tape 1600 creates a seal along the seam 2108 without having to seal over the tab 2105.

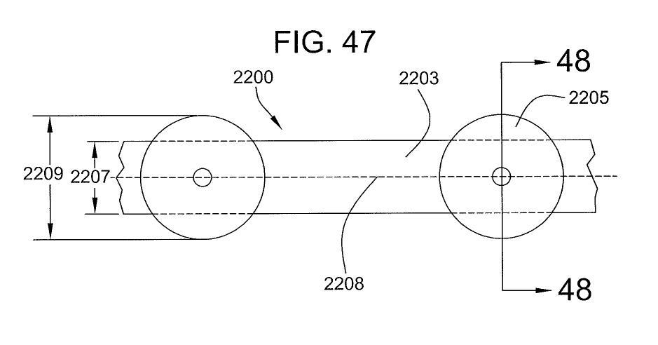

FIG. 47 shows a top view of another embodiment of the seam tape. The seam tape 2200 may include a substrate 2203 and tabs 2205. The substrate 2203 has a width 2207 which is narrower than the width 2209 of the tab 2205. The width 2207 may have a first range of about 0.25 inches (0.64 cm) to about 2 inches (5.1 cm), a second range of about 0.25 inches (0.64 cm) to about 1 inch (2.54 cm), and a third range of about 0.375 inches (0.95 cm) to about 0.75 inches (1.91 cm). In one embodiment, the width 2207 may be about 0.5 inches (1.27 cm). By having the width 2207 of the substrate 2203 narrower than the width 2209 of the tab 2205, the cost of the product may be reduced versus having a substrate which is wider than the tab.

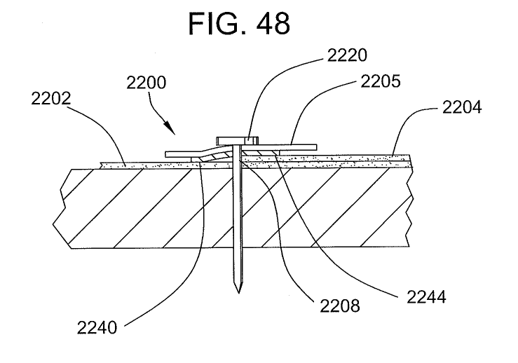

FIG. 48 shows a cross-sectional view through the seam tape 2200 at line 48-48 in FIG. 47. The cross-sectional view is taken through the tab 2205 and the fastener 2220. Due to the adhesive on the tape 2200, the tape adheres to the roofing paper 2202 and location 2240 and to the roofing paper 2204 at location 2244. Thus, the tape 2200 creates a seal along the seam 2208 without having to seal over the tab 2205.

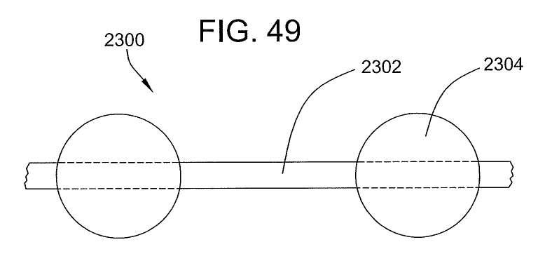

FIG. 49 shows another embodiment of the field tape. The field tape 2300 may include a substrate 2302 and tabs 2304. In this embodiment, the tabs 2304 may be mounted above the substrate 2302. The substrate 2302 may include an adhesive on the lower surface which will engage the roofing paper. In addition, the substrate 2302 may include an adhesive on the upper surface in order to attach the tab 2304 to the upper surface of the substrate 2302. The tab 2304 may also be attached to the upper surface of the substrate 2302 with a sealant or other material.

All of the devices noted above could be used with either the seam tape or the field tape, as appropriate.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Exemplary embodiments of this invention are described herein. Variations of those embodiments may become apparent to those of ordinary skill in the art upon reading the foregoing description. The inventor(s) expect skilled artisans to employ such variations as appropriate, and the inventor(s) intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A tape for application to a roofing material comprising a substrate, tabs, and an adhesive.

2. The tape as in claim 1 wherein the adhesive is on the substrate.

3. The tape as in claim 1 wherein the tabs are attached to the substrate using the adhesive.

4. The tape as in claim 1 wherein the adhesive will engage the roofing material.

5. The tape as in claim 1 wherein the substrate is wider than the tabs.

6. The tape as in claim 1 wherein the substrate is narrower than the tabs.

7. The tape as in claim 1 wherein a roofing material has a seam, the substrate overlaps the seam.

8. A method for applying a tape to a roof, comprising the steps of:
providing a roofing material on a roof;
providing a tape including a substrate and tabs attached to the substrate with an adhesive; and
applying the tape to the roofing material.

9. The method as in claim 8 wherein the roofing material has a seam, applying the substrate over a seam.

10. The method as in claim 9 wherein the tape establishes a seal for a seam.

11. The method as in claim 8 further comprising the step of applying a fastener to a tab.

12. A device for assembling roofing tabs to a substrate comprising a spindle to dispense a roll of a substrate, a feed tube to dispense roofing tabs and an actuating device disposed below the feed tube to attach tabs to a substrate.

13. The device as in claim 12 wherein the actuating device is a cam.

14. The device as in claim 12 further comprising a spindle to accumulate the assembled substrate and tabs.

15. A method of assembling roofing tabs to a substrate comprising the steps of:
providing a substrate;
providing an adhesive;
providing roofing tabs; and
attaching the roofing tabs to the substrate with the adhesive.

16. The method as in claim 15 further comprising the steps of providing the substrate on a roll and providing a spindle to dispense the roll of the substrate.

17. The method as in claim 15 further comprising the step of providing a feed tube to dispense roofing tabs.

18. The method as in claim 17 further comprising the step of providing an actuating device disposed below the feed tube to attach the tabs to the substrate.

19. The method as in claim 18 wherein the actuating device is a cam.

20. An applicator for applying a roll of roofing tape, the roofing tape includes a substrate and roofing tabs, the applicator comprising a support portion and a spindle, the spindle is connected to the support portion, wherein the roofing tape is connected to the spindle.

21. The applicator as in claim 20 wherein the spindle includes a hub.

22. The applicator as in claim 20 wherein a support portion is a shaft.

23. The applicator as in claim 22 further comprising a second shaft and a pressure roller attached t o the second shaft.

24. The applicator as in claim 20 wherein the support portion is a support plate, a handle is connected to the support plate, and a pressure roller is connected to the support plate.
